(19) United States
(12) Patent Application Publication
(10) Pub. No.: US 2003/0019139 A1
(43) Pub. Date: Jan. 30, 2003

(54) Accesory ball system

(76) Inventor: Michelle M. Cook, Arlington, TX (US)

Correspondence Address: Michael S. Neustel, Suite No. 4, 2534 South University Drive, Fargo, ND, 58103, US

(21) Appl. No.: 09/916,718

(22) Filed: Jul. 26, 2001

(51) Int. Cl. G09F 21/04

(52) U.S. Cl. 40/591

(57) ABSTRACT

An accessory ball system for providing a versatile and visually appealing device that promotes allegiance to an entity. The accessory ball system includes a spherical ball having an upper portion and a lower portion, a plurality of streamers attached to a rear portion of the ball via a conventional fastener or partially secured within an aperture within the ball, and a lower opening for securing upon a pole structure. The ball is preferably constructed of a solid structure wherein the outer surface of the upper portion and the lower portion are comprised of different colors representing an entity such as a school. The plurality of streamers are preferably comprised of one or more colors to represent the entity the individual desires to show allegiance to. In an alternative embodiment, the lower opening extends completely through the ball into an upper opening for receiving elongated objects such as shoelaces. Various other attaching structures may be utilized such as hooks and brackets for attaching to various structures.

### BACKGROUND OF THE INVENTION

1. Field of the Invention

The present invention relates generally to antenna balls and more specifically it relates to an accessory ball system for providing a versatile and visually appealing device that may be attached to various objects and structures.

2. Description of the Prior Art

Antenna balls have been in use for years. Typically, an antenna ball is comprised of a hollow structure that is attached about an antenna a vehicle. The antenna ball is typically constructed of a spherical structure, however various other shapes and designs have been utilized to construct these devices. IN-CONCEPT, INC. sells various designs of antenna balls (www.antennaballs.com).

The main problem with conventional antenna balls is that they are designed solely to be utilized upon automobile antennas and therefore cannot be easily attached to other structures. A further problem with conventional antenna balls is that they often times do not provide a visually stimulating and moving appearance as many users desire because of their relatively small size. Another problem is that conventional antenna balls do not consistently draw attention to themselves.

While these devices may be suitable for the particular purpose to which they address, they are not as suitable for providing a versatile and visually appealing device that promotes allegiance to an entity. Conventional antenna balls do not provide a visually stimulating structure and are not effective in attracting attention to themselves.

In these respects, the accessory ball system according to the present invention substantially departs from the conventional concepts and designs of the prior art, and in so doing provides an apparatus primarily developed for the purpose of providing a versatile and visually appealing device that promotes allegiance to an entity.

### SUMMARY OF THE INVENTION

In view of the foregoing disadvantages inherent in the known types of antenna balls now present in the prior art, the present invention provides a new accessory ball system construction wherein the same can be utilized for providing a versatile and visually appealing device that promotes allegiance to an entity.

The general purpose of the present invention, which will be described subsequently in greater detail, is to provide a new accessory ball system that has many of the advantages of the antenna balls mentioned heretofore and many novel features that result in a new accessory ball system which is not anticipated, rendered obvious, suggested, or even implied by any of the prior art antenna balls, either alone or in any combination thereof.

To attain this, the present invention generally comprises a spherical ball having an upper portion and a lower portion, a plurality of streamers attached to a rear portion of the ball via a conventional fastener or partially secured within an aperture within the ball, and a lower opening for securing upon a pole structure. The ball is preferably constructed of a solid structure wherein the outer surface of the upper portion and the lower portion are comprised of different colors representing an entity such as a school. The plurality of streamers are preferably comprised of one or more colors to represent the entity the individual desires to show allegiance to. In an alternative embodiment, the lower opening extends completely through the ball into an upper opening for receiving elongated objects such as shoelaces. Various other attaching structures may be utilized such as hooks and brackets for attaching to various structures.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide an accessory ball system that will overcome the shortcomings of the prior art devices.

A second object is to provide an accessory ball system for providing a versatile and visually appealing device that promotes allegiance to an entity.

Another object is to provide an accessory ball system that promotes an individual's allegiance to a specific entity such as a school, team, business or other entity.

An additional object is to provide an accessory ball system that may be attached to a vehicle antenna, a pole structure, shoelaces, zipper hooks, hair accessories, bicycles, tricycles, scooters, motorcycles and other objects.

A further object is to provide an accessory ball system that visually attracts viewers.

Another object is to provide an accessory ball system that provides movement when encountering air movement.

A further object is to provide an accessory ball system that displays an entity's colors.

Another object is to provide an accessory ball system that may be utilized with respect to special events such as fundraisers.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention.

FIG. 2 is an upper perspective view of the present invention attached to a pole or antenna.

FIG. 3 is an exploded upper perspective view of the present invention with respect to a pole or antenna.

FIG. 4 is a lower exploded upper perspective view of the present invention with respect to a pole or antenna disclosing the lower opening within the ball.

FIG. 5 is a side view of the present invention attached to a pole or antenna.

FIG. 6 is a bottom view of the present invention.

FIG. 7 is a top view of the present invention.

FIG. 8 is a rear view of the present invention attached to a pole or antenna.

FIG. 9 is a cross sectional view taken along line 9-9 of FIG. 7 of the present invention attached to a pole or antenna disclosing the streamers secured to the exterior surface of the ball by a fastener.

FIG. 10 is a cross sectional view taken along line 9-9 of FIG. 7 of the present invention attached to a pole or antenna disclosing the streamers secured within the interior portion of the ball.

FIG. 11 is a side view of an alternative embodiment of the present invention disclosing a lower opening connected to an upper opening for receiving an elongate object.

FIG. 12 is a side cutaway view of the alternative embodiment illustrated in FIG. 11.

FIG. 13 is a side view of a second alternative embodiment of the present invention illustrating a bracket attached to the lower portion of the ball.

FIG. 14 is a side view of a third alternative embodiment of the present invention illustrating a chain and hook attached to the lower portion of the ball.

### DESCRIPTION OF THE PREFERRED EMBODIMENT

Turning now descriptively to the drawings, in which similar reference characters denote similar elements throughout the several views, FIGS. I through 14 illustrate an accessory ball system 10, which comprises a spherical ball 20 having an upper portion 22 and a lower portion 24, a plurality of streamers 30 attached to a rear portion of the ball 20 via a conventional fastener or partially secured within an aperture within the ball 20, and a lower opening 26 for securing upon a pole structure 12. The ball 20 is preferably constructed of a solid structure wherein the outer surface of the upper portion 22 and the lower portion 24 are comprised of different colors representing an entity such as a school. The plurality of streamers 30 are preferably comprised of one or more colors to represent the entity the individual desires to show allegiance to. In an alternative embodiment, the lower opening 26 extends completely through the ball 20 into an upper opening 28 for receiving elongated objects such as shoelaces 14. Various other attaching structures may be utilized such as hooks 50 and brackets 40 for attaching to various structures.

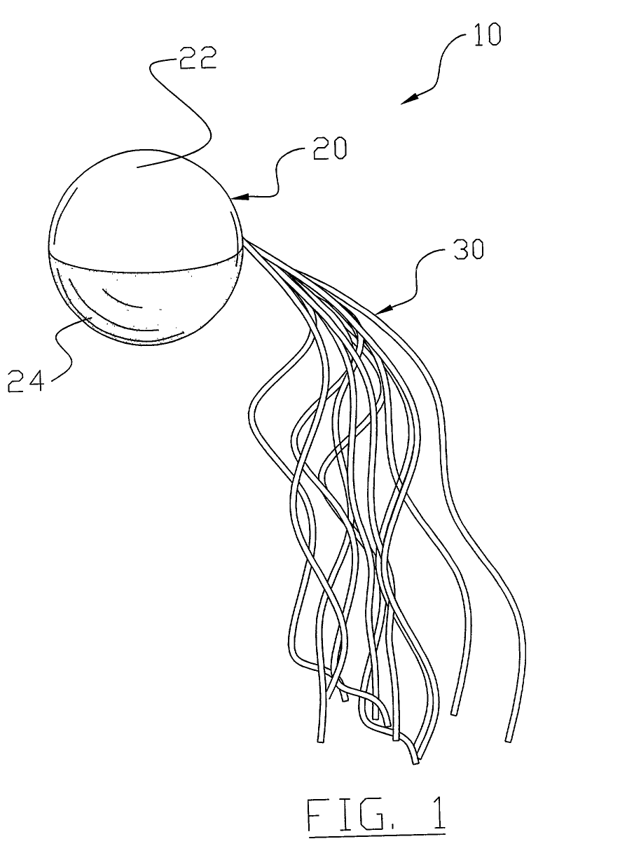

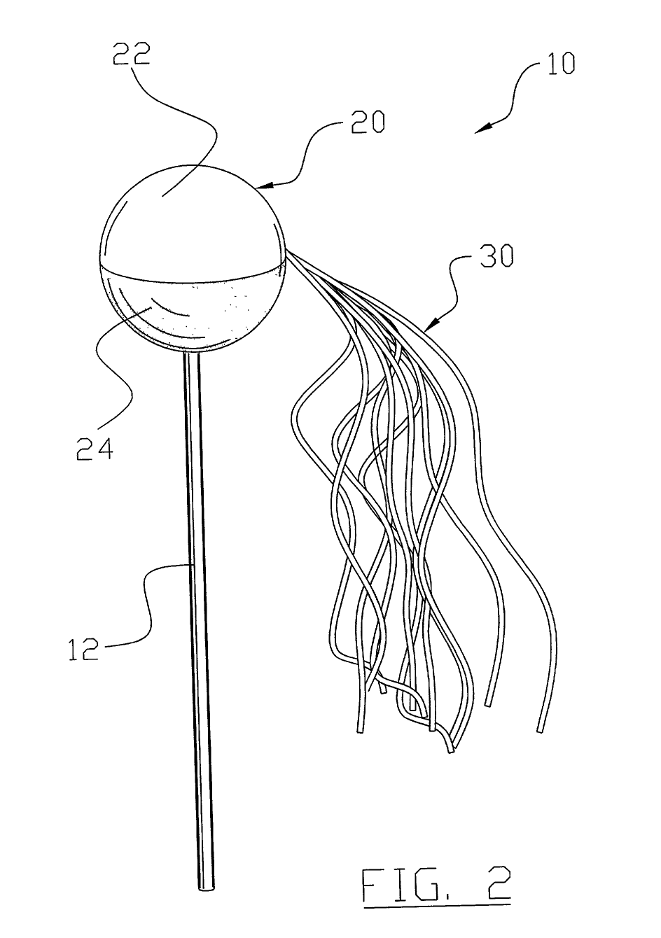

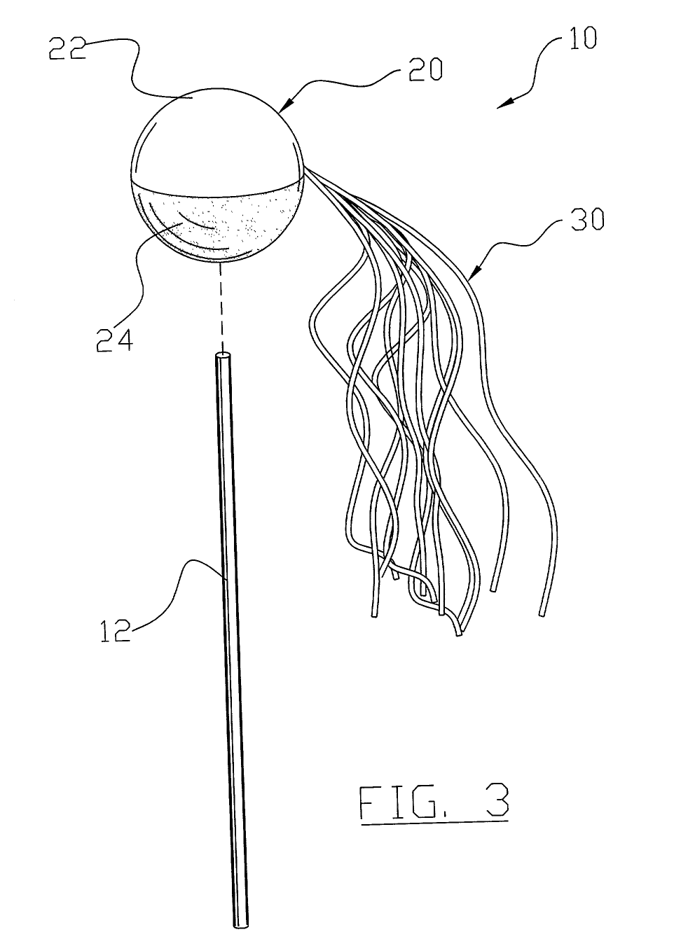

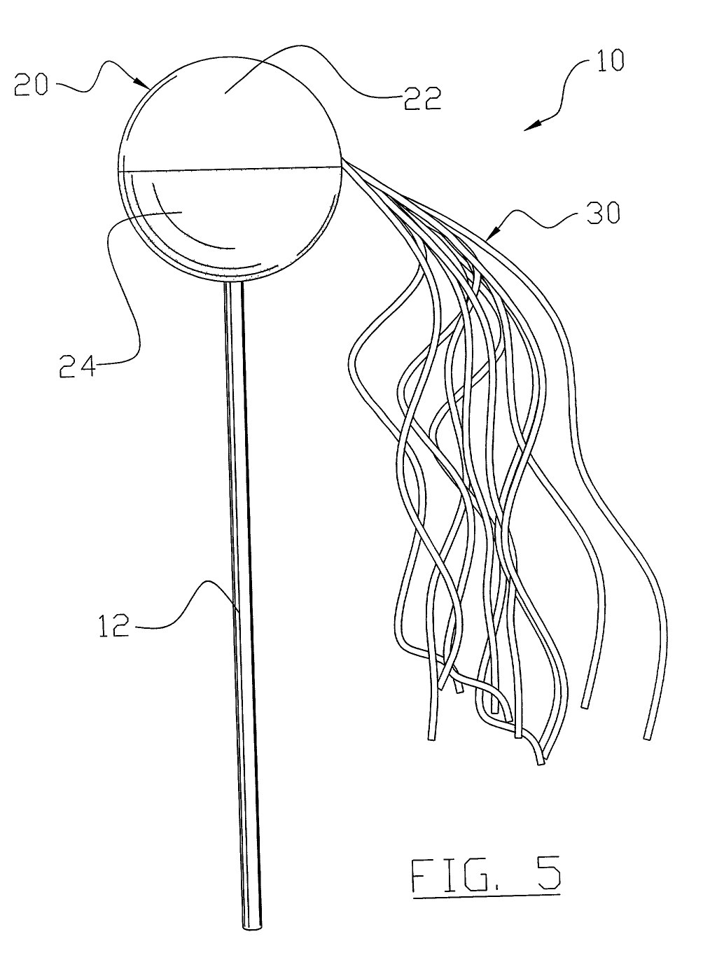

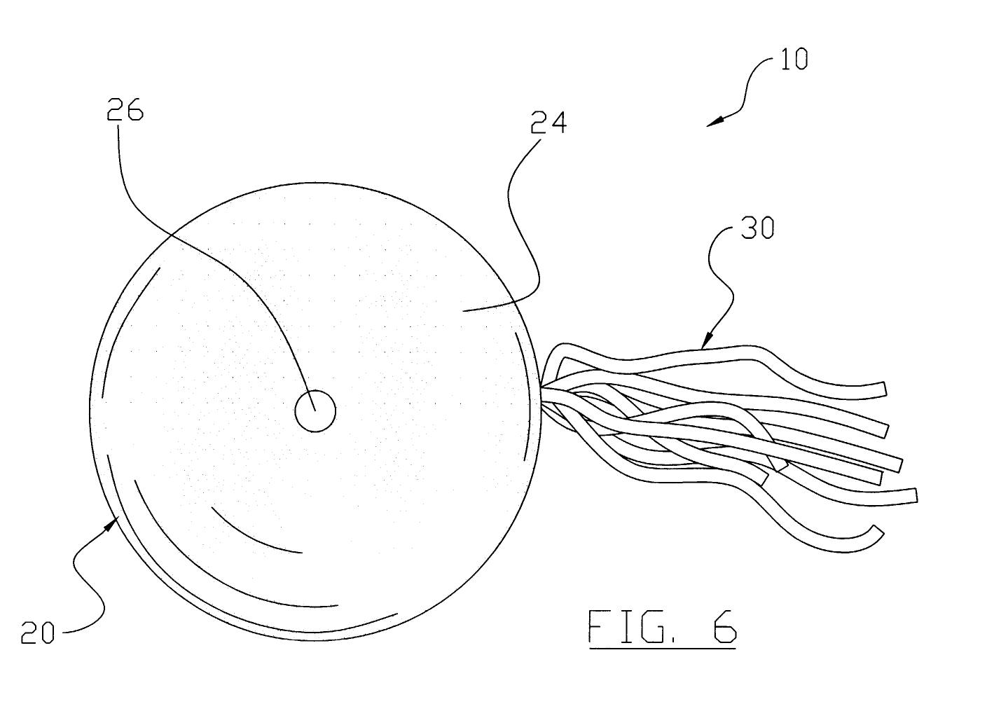

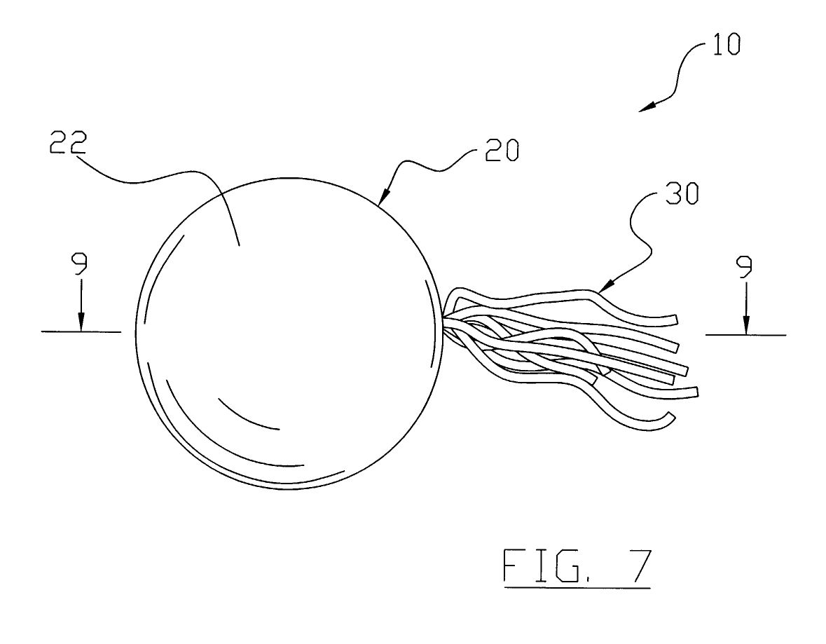

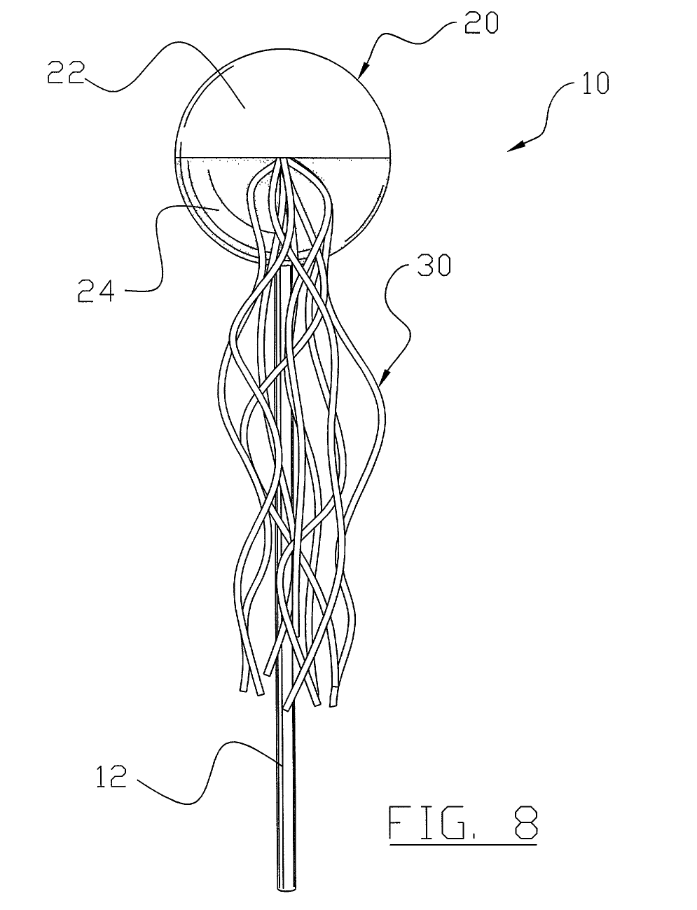

As illustrated in FIGS. 1 through 14 of the drawings, the ball 20 is a spherical structure having an upper portion 22 and a lower portion 24. The ball 20 is preferably comprised of a solid material such as but not limited to rubber, foam, foam rubber, STYROFOAM, foam rubber, plastic and other common materials. The ball 20 may have various sizes as can be appreciated.

The upper portion 22 of the ball 20 preferably has a color different than the color of the lower portion 24. The colors of the upper portion 22 and the lower portion 24 may be applied as a conventional paint or included within the manufacturing material prior to manufacturing the ball 20.

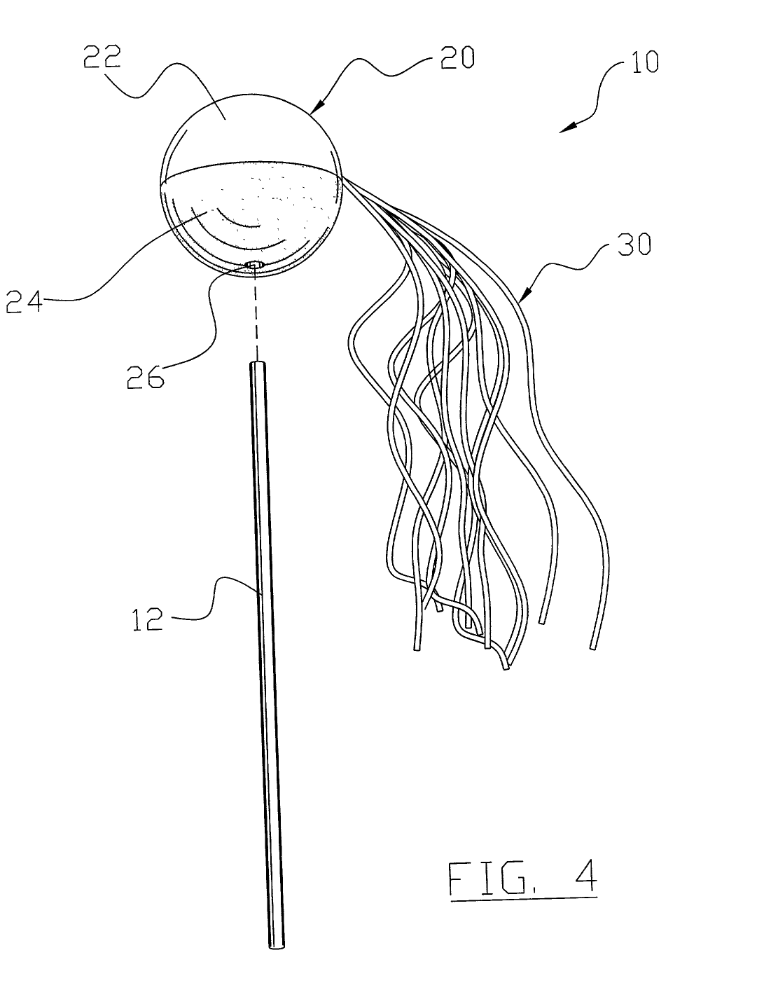

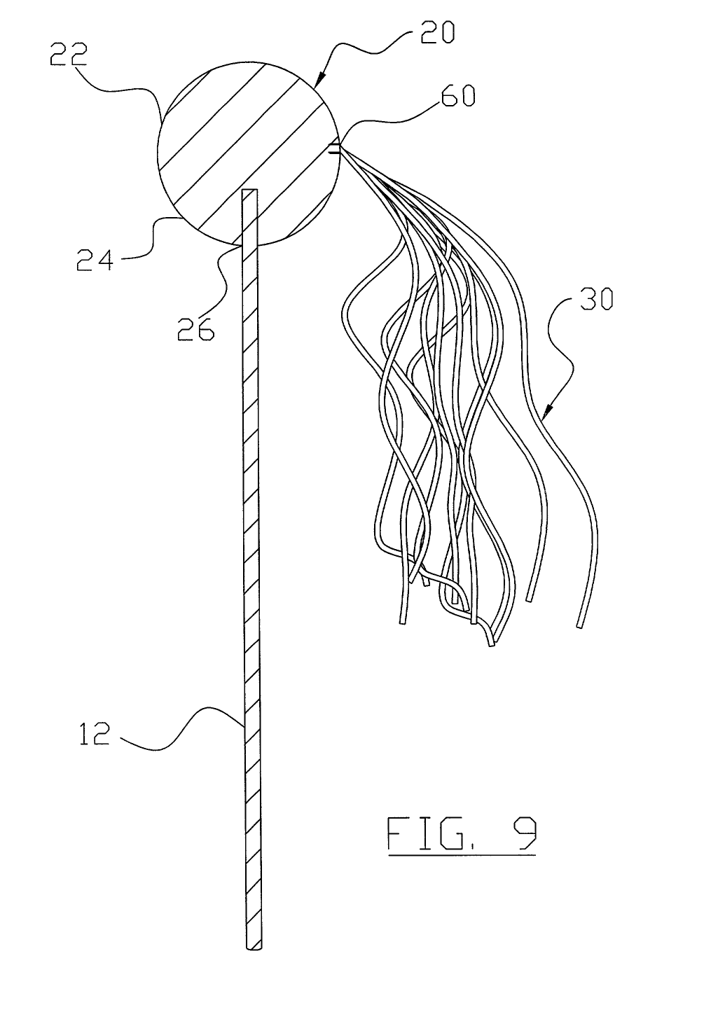

As shown in FIGS. 4, 6 and 9 of the drawings, the lower portion 24 of the ball 20 includes a lower opening 26 for receiving a pole structure 12 or similar elongate object. The lower opening 26 extends a finite distance into the ball 20 as best illustrated in FIG. 9 of the drawings. The lower opening 26 is preferably formed for snugly receiving the pole structure 12 to prevent accidental removal of the ball 20 during usage. The pole structure 12 may be comprised of various objects such as a plastic stick, a metal stick, a wood stick, a vehicle antenna, or other elongate object.

As further shown in FIGS. 1 through 14 of the drawings, a plurality of streamers 30 are attached to the rear portion of the ball 20 between the upper portion 22 and the lower portion 24. The plurality of streamers 30 may be comprised of various flexible materials and preferably are comprised of at least one color. The plurality of streamers 30 may be comprised of a metallic appearing flexible structure as is commonly utilized within party streamers 30 and the like. The plurality of streamers 30 may have two or more colors within wherein the colors are grouped to represent a colored section within the streamers 30. The plurality of streamers 30 may have various lengths, widths and thickness as can be appreciated.

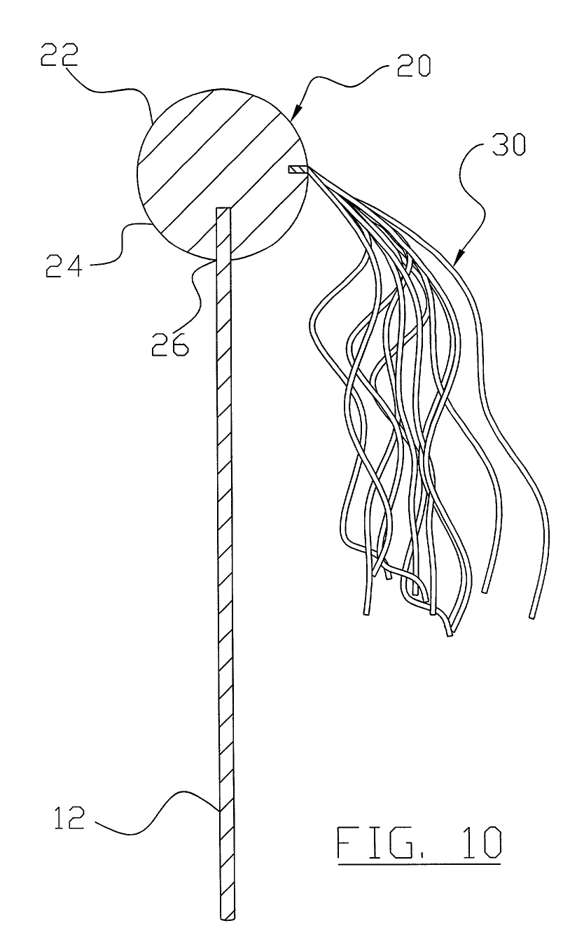

As shown in FIG. 9 of the drawings, the plurality of streamers 30 may be attached to the exterior of the ball 20 utilizing a conventional adhesive or fastener such as a staple or the like. As shown in FIG. 10 of the drawings, the plurality of streamers 30 may be inserted into an aperture within the ball 20 and secured within the aperture with pressure from the ball 20 or an adhesive. Various other attachment means may be utilized to secure the plurality of streamers 30 to the rear portion of the ball 20.

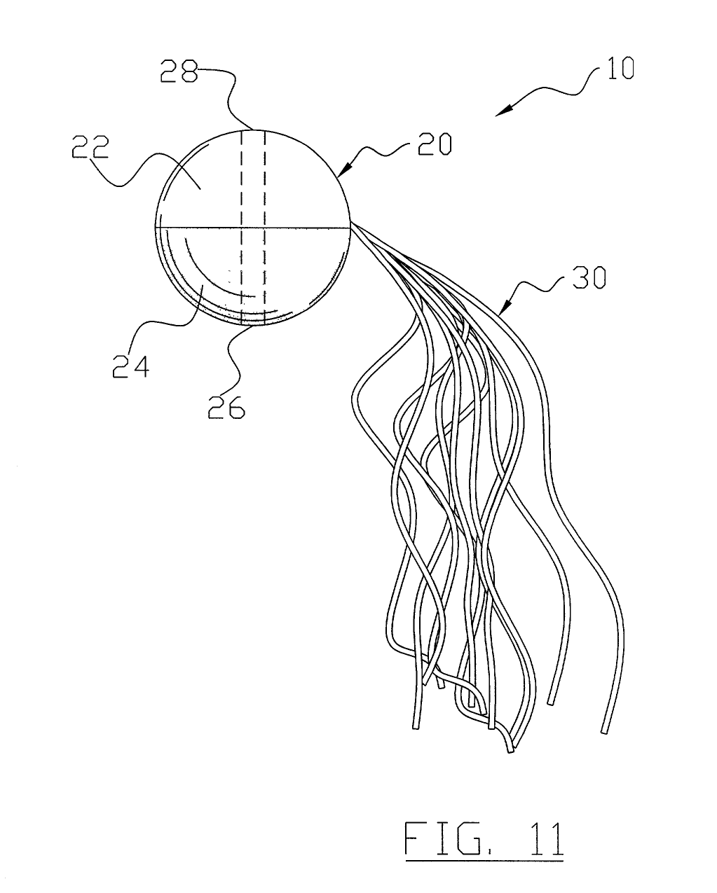

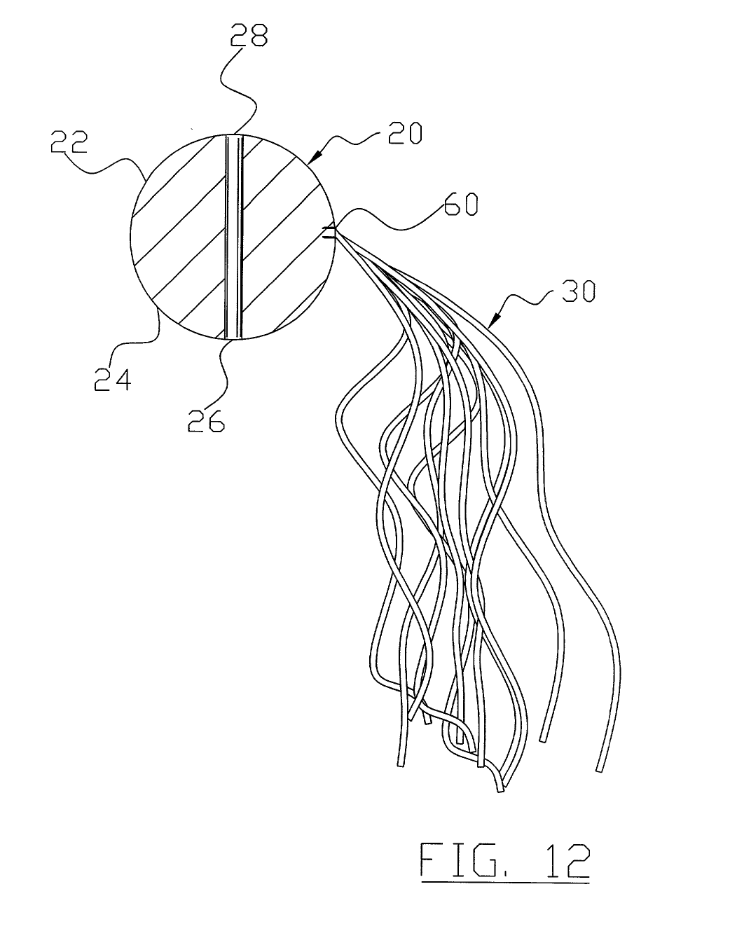

In an alternative embodiment shown in FIGS. 11 and 12 of the drawings, an upper opening 28 extends through the upper portion 22 of the ball 20. The upper opening 28 is connected to the lower opening 26 thereby forming a hole through the entire ball 20 for receiving an elongate object such as a shoelace 14 or the like. The user may also attach various other elongate objects through the hole created by the upper opening 28 and the lower opening 26 such as strings attached to clothing and the like. The hole may have various diameters as required to receive the elongate object.

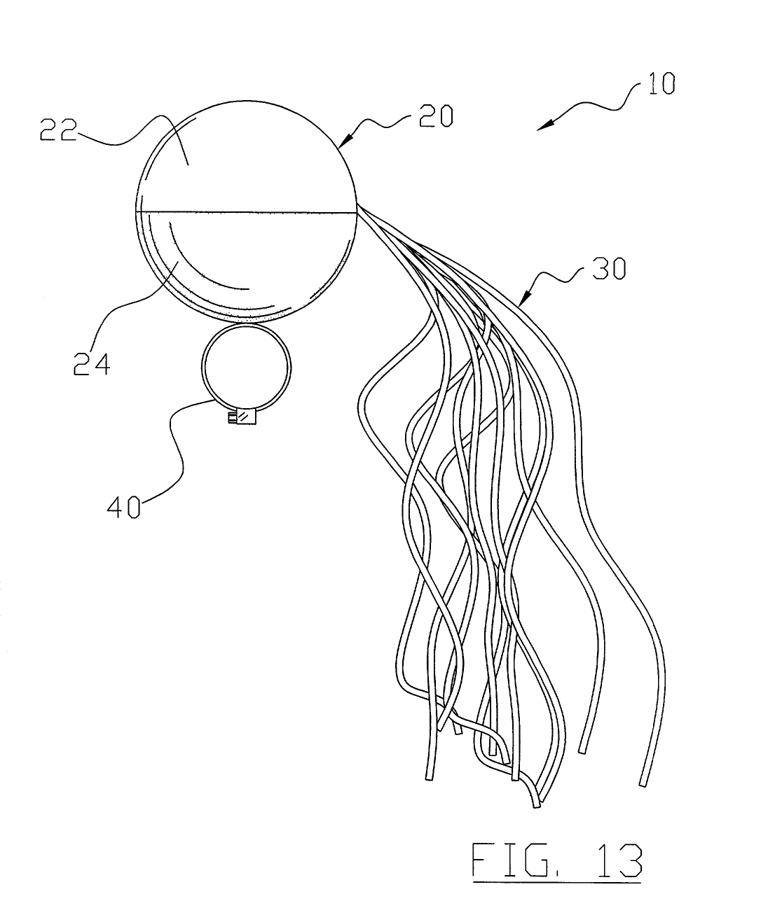

In a second alternative embodiment shown in FIG. 13, a bracket 40 is attached to the lower portion 24 of the ball 20. The bracket 40 is designed for being attached about an object such as but not limited to the handle bars of a bicycle, tricycle, motorcycle, scooter and the like. The bracket 40 is preferably comprised of a conventional circular bracket 40 that may be tightened about an object.

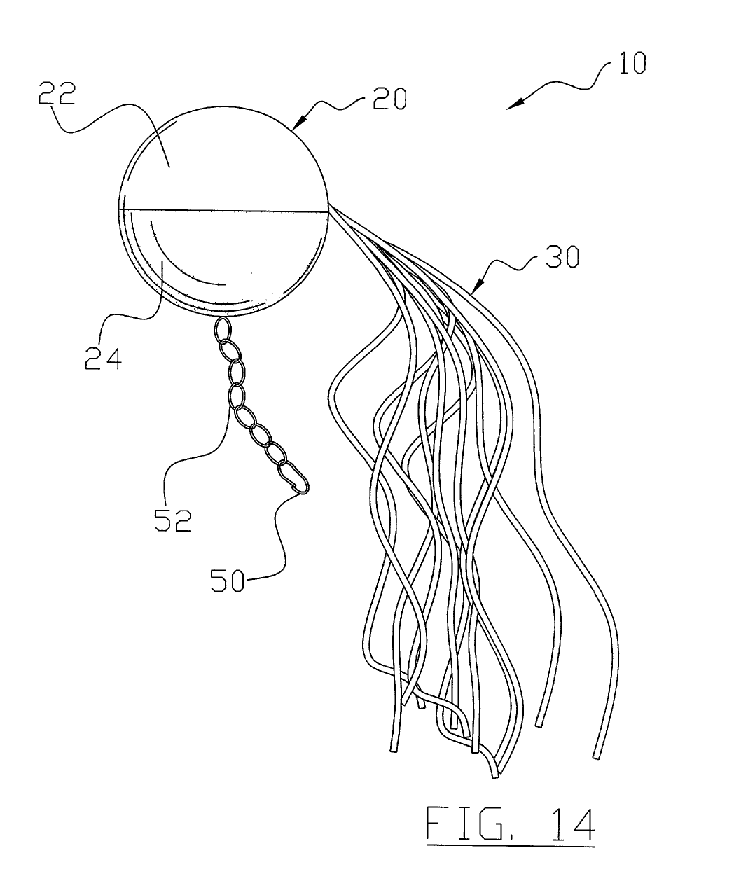

In a third alternative embodiment shown in FIG. 14, a length of chain 52 is attached to the lower portion 24 of the ball 20 with a hook 50 attached to the distal end of the chain 52. The hook 50 may be attached to various objects such as but not limited to zipper hooks, clothing, belts and the like.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An accessory ball system, comprising:
a ball having a spherical structure, wherein said ball includes a lower portion and an upper portion each comprising approximately 50% of said ball and each having a different color;
a plurality of streamers attached to a rear portion of said ball between said lower portion and said upper portion of said ball; and
a lower opening within said lower portion of said ball for fitting snugly fitting about an elongate structure.

2. The accessory ball system of claim 1, wherein said plurality of streamers are each comprised of an equal length.

3. The accessory ball system of claim 2, wherein said plurality of streamers include at least two different colors.

4. The accessory ball system of claim 2, wherein said plurality of streamers include at least two sections of streamers, wherein each of said at least two sections of streamers having different colors.

5. The accessory ball system of claim 1, wherein said plurality of streamers have a metallic appearance.

6. The accessory ball system of claim 1, wherein said plurality of streamers are attached to said rear portion of said ball by a fastener.

7. The accessory ball system of claim 1, wherein said plurality of streamers are inserted into said ball a finite distance and attached by an adhesive.

8. The accessory ball system of claim 1, including an upper opening extending through said upper portion of said ball, wherein said upper opening is connected to said lower opening forming a hole through ball that is traverse to a common plane between said lower portion and said upper portion for receiving an elongate object.

9. The accessory ball system of claim 1, wherein said upper portion and said lower portion are each comprised of a material having a different color.

10. The accessory ball system of claim 1, wherein said ball is comprised of a solid structure.

11. An accessory ball system, comprising:
a ball having a spherical structure, wherein said ball includes a lower portion and an upper portion each comprising approximately 50% of said ball and each having a different color;
a plurality of streamers attached to a rear portion of said ball between said lower portion and said upper portion of said ball;
a lower opening within said lower portion of said ball for fitting snugly fitting about an elongate structure;
a length of chain attached to said lower portion of said ball; and
a hook attached to a distal end of said chain.

12. The accessory ball system of claim 11, wherein said plurality of streamers are each comprised of an equal length.

13. The accessory ball system of claim 12, wherein said plurality of streamers include at least two different colors.

14. The accessory ball system of claim 12, wherein said plurality of streamers include at least two sections of streamers, wherein each of said at least two sections of streamers having different colors.

15. The accessory ball system of claim 11, wherein said plurality of streamers have a metallic appearance.

16. The accessory ball system of claim 11, wherein said plurality of streamers are attached to said rear portion of said ball by a fastener.

17. The accessory ball system of claim 11, wherein said plurality of streamers are inserted into said ball a finite distance and attached by an adhesive.

18. The accessory ball system of claim 11, wherein said upper portion and said lower portion are each comprised of a material having a different color.

19. The accessory ball system of claim 11, wherein said ball is comprised of a solid structure.

20. An accessory ball system, comprising:
a ball having a spherical structure, wherein said ball includes a lower portion and an upper portion each comprising approximately 50% of said ball and each having a different color;
a plurality of streamers attached to a rear portion of said ball between said lower portion and said upper portion of said ball; and
a bracket having a circular structure attached to said lower portion of said ball for attaching to elongate objects.
